(19) United States
(12) Patent Application Publication
(10) Pub. No.: US 2026/0054516 A1
(43) Pub. Date: Feb. 26, 2026

(54) Birdsmouth Jig

(71) Applicant: Daniel Wayne McGee, Young, AZ (US)

(72) Inventor: Daniel Wayne McGee, Young, AZ (US)

(21) Appl. No.: 18/987,008

(22) Filed: Dec. 19, 2024

Related U.S. Application Data
(60) Provisional application No. 63/557,949, filed on Feb. 26, 2024.

(51) Int. Cl. B43L 7/12

(52) U.S. Cl. CPC B43L 7/12

(57) ABSTRACT

A birdsmouth jig includes a base having an inside edge, a square having a first leg with a first outside edge and a second leg with a second outside edge meeting at and defining a corner, wherein the square is mounted to the base for sliding movement along the base.

### CROSS-REFERENCE TO RELATED APPLICATIONS

This application claims the benefit of U.S. Provisional Application No. 63/557,949, filed Feb. 26, 2024, which is hereby incorporated by reference in its entirety.

### FIELD

The present specification relates generally to hand tools, and more particularly to carpenter tools and framing squares.

### BACKGROUND

Carpenters and other tradesmen use a variety of tools in their lines of work. Some tools are specifically designed for certain jobs, while other tools are useful in a wide range of applications. One tool that is frequently used is a carpenter's framing square, which is conventionally a large flat tool with two legs of different lengths arranged at a right angle to each other. Framing squares are frequently used to mark “birdsmouth” cut lines for stringers on a beam. However, these cut lines have to be precisely and consistently made along the beam, and it is surprisingly difficult and time-intensive to do so with a framing square. There is a need to improve the conventional framing square.

### SUMMARY

In an embodiment, a birdsmouth jig includes a base having an inside edge, a square having a first leg with a first outside edge and a second leg with a second outside edge meeting at and defining a corner. The square is mounted to the base for sliding movement along the base.

In embodiments, the square is mounted to the base for articulated movement at two spaced-apart points. The square is mounted to the base at two spaced-apart points, each of which is configured to reciprocate along two offset lines of reciprocal movement. The square includes first and second slides mounted to the base for reciprocal movement in a first direction. The first and second slides are mounted to the square for reciprocal movement in a second direction. The slides each include a nut having a body, and the body has an upper face. A set screw is threadably engaged in the body and has a lower face opposing the upper face and defining a securement gap therebetween. The nut includes two threaded bores spaced apart from each other on the upper face, each being configured to receive the set screw.

In an embodiment, a birdsmouth jig includes a base having an inside edge extending along a first track portion and an opposed second track portion of the base, and a square having a first leg with a first outside edge and a second leg with a second outside edge meeting at and defining a corner. The first leg of the square is mounted to the first track portion of the base for sliding movement, and the second leg of the square is mounted to the second track portion of the base for sliding movement.

In embodiments, the first and second track portions are separated by a grip between the first and second portions. The first and second track portions each include an elongate slot carrying a slide which slidably couples the square to the base. Each slide is carried in the respective elongate slot for reciprocal movement. The slide mounted in the elongate slot in the first track portion is carried for reciprocal movement in the first track portion along a first direction;

The slide is mounted in the elongate slot in the second track portion is carried for reciprocal movement in the second track portion along a second direction. The first direction is perpendicular to the second direction. The slides each include a nut having a body having an upper face. A set screw is threadably engaged in the body and has a lower face opposing the upper face and defining a securement gap therebetween. The nut includes two threaded bores spaced apart from each other on the upper face, each being configured to receive the set screw.

In an embodiment, a birdsmouth jig includes a base having an inside edge extending along both a first portion and an opposed second portion, and a square having a first leg with a first outside edge and a second leg with a second outside edge meeting at and defining a corner. The square is mounted to the base for movement along a first direction extending along the first leg and along a second direction extending along the second leg. Movement along the base in either of the first and second directions imparts pivotal movement of the corner with respect to the inside edge.

In embodiments, the square is mounted to the base for movement along a third line extending along the base. The first leg of the square is mounted to the first portion of the base for sliding movement along the first direction, and the second leg of the square is mounted to the second portion of the base for sliding movement along the second direction.

The base includes first and second track portions, each having an elongate slot carrying a slider to which the square is coupled. The first and second track portions are separated by a grip. The slide carried in the elongate slot in the first track portion is carried for reciprocal movement in the first track portion along a first direction. The slide carried in the elongate slot in the second track portion is carried for reciprocal movement in the second track portion along a second direction. The first direction is perpendicular to the second direction. The slides each include a nut having a body with an upper face and a set screw threadably engaged in the body. The set screw has a lower face opposing the upper face and defining a securement gap therebetween. The nut includes two threaded bores spaced apart from each other on the upper face, each being configured to receive the set screw.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1 is a top perspective view of a birdsmouth jig;

FIG. 2 is a bottom perspective view of the birdsmouth jig;

FIG. 3 is an exploded, top perspective view of the birdsmouth jig;

FIG. 4 is a top plan view of the birdsmouth jig applied against a workpiece in a first position;

FIG. 5 is a top plan view of the birdsmouth jig applied against a workpiece in a second position; and

FIGS. 6 and 7 are top plan views of alternate embodiments of a square for a birdsmouth jig.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

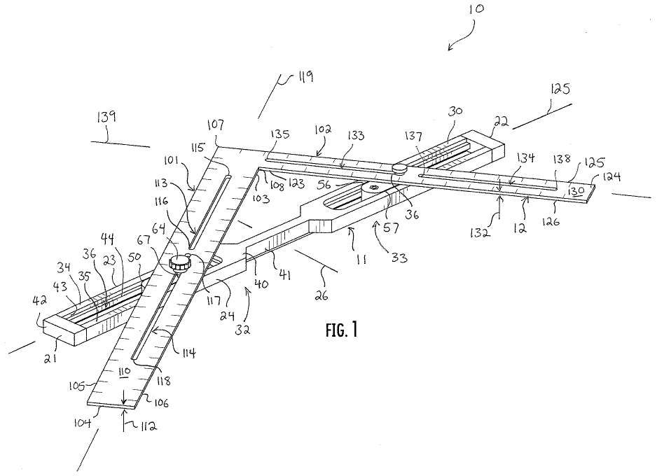

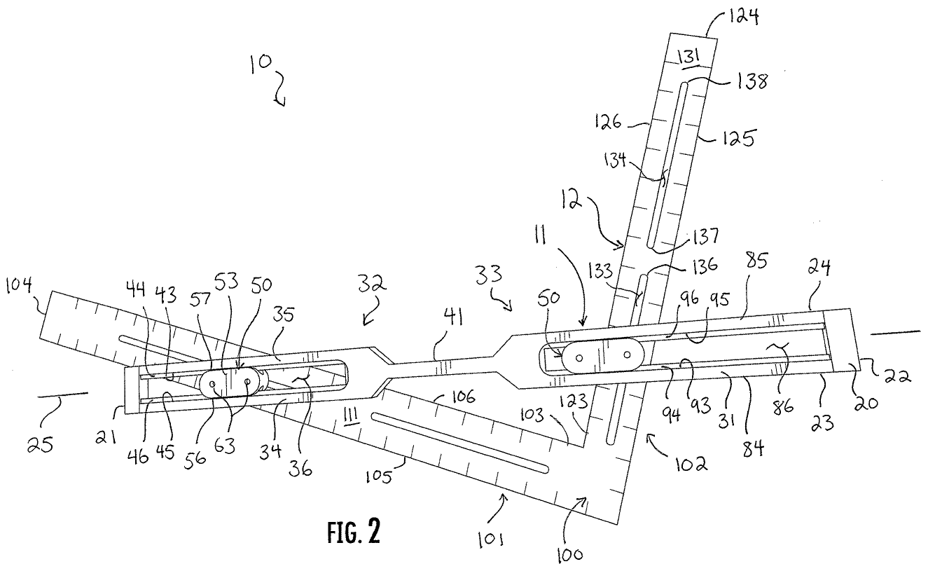

FIGS. 1 and 2 are top and bottom perspective views of a birdsmouth jig 10 including an elongate base 11 and a carpenter's square 12 mounted to the base 11 for articulated, sliding movement along the base 11 at two-spaced apart and moveable points. The jig 10 is useful for quickly setting a desired birdsmouth-style shape with which to consistently make accurate marks on a piece of lumber.

The base 11 has an elongate body 20 extending from a first end 21 to a second end 22, with opposed first and second long edges 23 and 24 extending entirely between those. In this embodiment, the base 11 has symmetry about a long axis 25 as well as about a short axis 26. When the square 12 is applied to the base 11 as shown in FIG. 1, the first edge 23 is an inside edge, and so the description here contemplates such an arrangement. However, if the orientation of the base 11 were reversed, then the second edge 24 would be an inside edge. The inside edge is the edge 23 or 24 which faces inside, toward the piece of lumber. Consequently, the other edge 24 or 23 becomes the outside edge. The body 20 also includes upper and lower faces 30 and 31 which are both flat and parallel to each other.

The base 11 has two elongate track portions or lobes 32 and 33. A first track lobe 32 is proximate the first end 21, and a second track lobe 33 is proximate the second end 22. The two track lobes 32 and 33 are identical and opposite.

In the first track lobe 32, the body 20 of the base 11 expands into two parallel rails 34 and 35 spaced apart by a slot 36. The first and second rails 34 and 35 begin at an inner end 40 of the first track lobe 32, where the body 20 transitions from a narrowed grip 41 to the wider first track lobe 32, and extends along the length of the first track lobe 32 to an endwall 42 at the first end 21 of the body 20. In the embodiment shown in these drawings, the endwall 42 is a separate piece of material sized and shaped and adhered to fit securely to the rails 34 and 35. The rails 34 and 35, together with the endwall 42, thus define the slot 36.

The first rail 34 has an inner surface 43 directed inwardly into the slot 36. A tongue 44 projects inwardly into the slot 36 from the inner surface 43, extending beyond the inner surface 43 by a distance approximately one-half of its height between the upper and lower faces 30 and 31. The tongue 44 is located approximately halfway between the upper and lower faces 30 and 31, and it extends along the entire length of the slot 36.

The second rail 34 has identical and mirrored structure: it includes an inner surface 45 directed inwardly into the slot 36 with a tongue 46, best shown in FIG. 2. The tongue 46 extends beyond the inner surface 45 by a distance approximately one-half of its height between the upper and lower faces 30 and 31. The tongue 46 is located approximately halfway between the upper and lower faces 30 and 31, and it extends along the entire length of the slot 36.

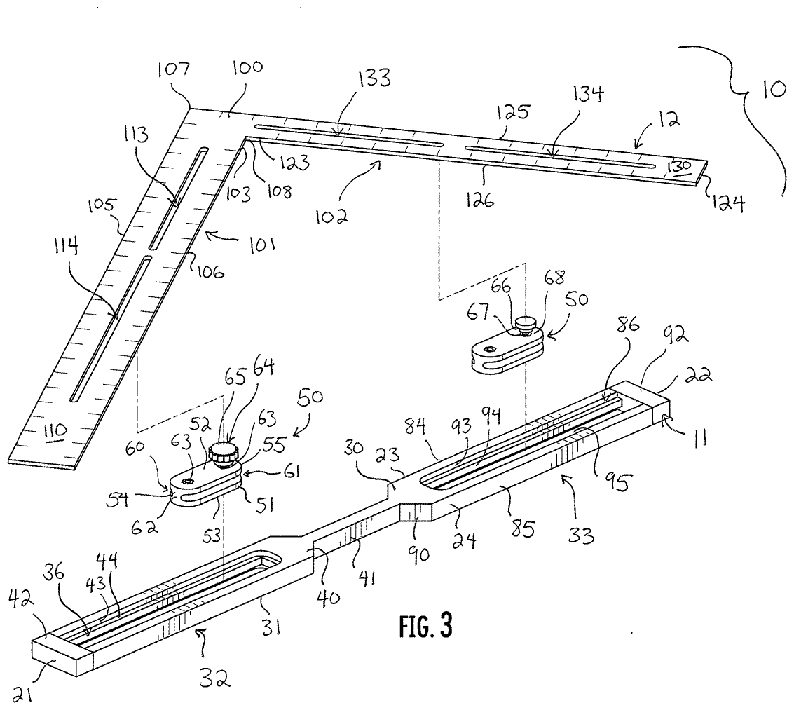

A nut 50 is carried in the slot 36. While FIGS. 1 and 2 do illustrate the nut 50, it is better shown in the exploded perspective view of FIG. 3. The nut 50 is also called a “slide.” It is a small sliding part that reciprocates within the slot 36 between the first end 21 and the inner end 40. The nut 50 has a generally elliptical prismatic body 51 with an upper face 52, an opposed lower face 53, and opposed first and second ends 54 and 55. The nut 50 further includes a first side 56 and a second side 57, both extending between the first and second ends 54 and 55, fully between the upper and lower faces 52 and 53.

A first groove 60 is formed into the first side 56, and a second groove 61 is formed into the second side 57. The grooves 60 and 61 extend inward toward each other to define a central rib 62 extending through the middle along the long axis of the nut 50. The rib 62 is slender because the grooves 60 and 61 extend nearly entirely through the nut 50.

Two spaced-apart threaded bores 63 are formed through the body 51 of the nut 50 entirely from the upper face 52 to the lower face 53. One bore 63 is proximate the first end 54 of the nut 50 and the other bore 63 is proximate the second end 55 of the nut 50. Both bores 63 are capable of receiving the set screw 64. A set screw 64 is threadably engaged to the bore 63 proximate the second end 55, though the set screw 64 may be secured to either bore 64 equally. The set screw 64 has a threaded shank 67 and an enlarged head 65 which a lower contact face 66. When the set screw 64 is engaged in the bore 63, the contact face 66 is parallel to the upper and lower faces 52 and 53, which are parallel to each other.

The nut 50 fits within the slot 36 for sliding reciprocal movement in either direction along the long axis 25, as shown in FIG. 2. When properly fit, the nut 50 is registered within the slot 36 with the lower face 53 of the nut 50 flush and parallel with the lower face 31 of the base 11 and the upper face 52 of the nut 50 flush and parallel with the upper face 30 of the base 11. Fit in this way, the nut 50 is capable of smoothly sliding the length of the slot 36 without binding.

When the nut 50 is fit in the slot 36, the first groove 60 closely receives the tongue 44 projecting into the slot 36 from the first rail 34 and the second groove 61 closely receives the tongue 46 projecting into the slot 36 from the second rail 35. The first and second grooves 60 and 61 are just slightly bigger than the tongues 44 and 46 so that the nut 50 can slide smoothly within the slot 36 without binding. The width of the nut 50 between its first and second sides 56 and 57 is just slightly smaller than the width of the slot 36 between the opposed inner surfaces 43 and 45, so that the nut 50 can slide smoothly within the slot 36 without binding.

The height of the nut 50, between its upper face 52 and lower face 53, is equal to the height of the base 11, between its upper face 30 and lower face 31. The nut 50 preferably does not extend beyond the upper and lower faces 30 and 31, nor is it preferably recessed with respect to the upper and lower faces 30 and 31.

The second track lobe 33 is identical to the first track lobe 32 but disposed on the other end of the base 11, proximate the second end 22.

The two track lobes 32 and 33 are spaced apart from each other by the grip 41. The grip 41 defines a narrowing of the body 20 with respect to the first and second track lobes 32 and 33. The first and second edges 23 and 24 turn in toward each other and come approximately halfway closer to each other along the grip 41 than along the first and second track lobes 32 and 33. The grip 41 is preferably a solid rectangular prismatic member connecting the first and second track lobes 32 and 33.

The grip 41 is formed integrally and monolithically to those first and second track lobes 32 and 33. The upper face 30 of the base 11 is flat and level across the entire base 11, including along the grip 41 and in the transitions between the grip 41 and the first and second track lobes 32 and 33. Similarly the lower face 31 of the base 11 is flat and level across the entire base 11, including along the grip 41 and in the transitions between the grip 41 and the first and second track lobes 32 and 33.

In the second track lobe 33, the body 20 of the base 11 expands into two parallel rails 84 and 85 spaced apart by a slot 86. The first and second rails 84 and 85 begin at an inner end 90 of the second track lobe 33, where the body 20 transitions from the narrow grip 41 to the wider second track lobe 33, and extends along the length of the second track lobe 33 to an endwall 92 at the first end 21 of the body 20. In the embodiment shown in these drawings, the endwall 92 is a separate piece of material sized and shaped and adhered to fit securely to the rails 84 and 85. The rails 84 and 85, together with the endwall 92, thus define the slot 86.

The first rail 84 has an inner surface 93 directed inwardly into the slot 86. A tongue 94 projects inwardly into the slot 86 from the inner surface 93, extending beyond the inner surface 93 by a distance approximately one-half of its height between the upper and lower faces 30 and 31. The tongue 94 is located approximately halfway between the upper and lower faces 30 and 31, and it extends along the entire length of the slot 86.

The second rail 84 has identical and mirrored structure: it includes an inner surface 95 directed inwardly into the slot 86 with a tongue 96, best shown in FIG. 2. The tongue 96 extends beyond the inner surface 95 by a distance approximately one-half of its height between the upper and lower faces 30 and 31. The tongue 96 is located approximately halfway between the upper and lower faces 30 and 31, and it extends along the entire length of the slot 86.

Another nut 50, identical to the nut 50 in the slot 36, is carried in the slot 86. Since the nut 50 is identical, no further description of it is necessary here, and the reader should understand its structure as well as its position and operation with respect to the slot 86 based on the description above regarding the nut 50 in the slot 36.

The carpenter's square 12 is mounted to the base 11 at both nuts 50 for sliding movement along the base 11. By sliding the square 12 into different positions with respect to the base 11, the carpenter can arrange for different types of birdsmouth cuts as needed. The carpenter need only loosen the nuts 50, move the square 12, and then tighten the nuts 50 to set one particular birdsmouth cut pattern, which he can then repeat over and over consistently along a piece of lumber. If he then needs to cut a different pattern, he can again loosen the nuts 50, move the square 12, and then tighten the nuts 50 to set the new cut pattern.

The term “carpenter's square” is a term of art, generally used to describe an L-shaped member; however, the scope of this description is not so limited. The square 12 could be a triangle, rectangle, actual square, or other shape, so long as it preferably has at least one right angle that can be positioned on one side of the base 11 to form the birdsmouth cut. In some situations, a cut may be needed which is more or less than ninety degrees, and in those situations, the square 12 would have another shape. All of these shapes are intended to be included within the scope of this description.

The square 12 has a first leg 101 and an offset second leg 102 meeting at and defining a center 100 of the square 12. The first leg 101 is slightly longer than the second leg 102. The first leg 101 has a base end 103 at the center 100 and an opposed free end 104. The first leg 101 is rectangular, having two parallel long sides or edges extending between the base end 103 and the free end 104. One of those sides is an outside edge 105 and the other is an inside edge 106. The outside edge 105 extends entirely from the free end 104 to an outside corner 107 formed in cooperation with the second leg 102. The inner edge 106 extends entirely from the free end 104 to an inside corner 108 formed in cooperation with the second leg 102, opposite the outside corner 107.

The first leg 101 also has an upper surface 110 and an opposed lower surface 111 that each extend entirely between the base end 103 and the free end 104 and between the opposed edges 105 and 106. The upper and lower surfaces 110 and 111 are flat, smooth, and parallel to each other, spaced apart by a small thickness 112 of the first leg 101.

The first leg 101 further includes two slits: a proximal slit 113 and a distal slit 114. Both slits 113 and 114 are formed entirely through the first leg 101, from the upper surface 110 through to the lower surface 111. The slits 113 and 114 are slender and straight. The proximal and distal slits 113 and 114 are formed along a medial line 119 in the first leg 101, extending centrally through the first leg 101. In other words, the proximal and distal slits 113 and 114 are each located roughly halfway between the outside and inside edges 105 and 106.

The proximal slit 113 has a proximal end 115 and an opposed distal end 116. The proximal end 115 is located just inboard of the center 100, and the distal end 116 is located at an approximate midpoint along the length of the first leg 101.

Likewise, the distal slit 114 has a proximal end 117 and an opposed distal end 118. The proximal end 117 is located just beyond the distal end 116 at the approximate midpoint of the first leg 101, and the distal end 118 is located inboard of the free end 104 by a distance equivalent to about twice the distance between the outside and inside edges 105 and 106.

As shown in FIGS. 1 and 2, the nut 50 is carried in the proximal and distal slits 113 and 114. In those drawings, the threaded shank 67 in the nut 50 extends through the distal slit 114, with the body 51 of the nut below the square 12 and the head 65 above the square 12. The nut 50 is also applicable to the proximal slit 113 in a similar fashion to the distal slit 114, which the reader will readily understand without further explanation. The nut 50 can be slid by the carpenter along the full lengths of both the proximal and distal slits 113 and 114.

The second leg 102 is slightly shorter than the first leg 101. The second leg 102 has a base end 123 at the center 100 and an opposed free end 124. The second leg 102 is rectangular, having two parallel long sides or edges extending between the base end 123 and the free end 124. One of those sides is an outside edge 125 and the other is an inside edge 126. The outside edge 125 extends entirely from the free end 124 to the outside corner 107 formed in cooperation with the first leg 101 (the two outside edges 105 and 125 meet at and define the corner 107). The inner edge 126 extends entirely from the free end 124 to the inside corner 108 formed in cooperation with the first leg 101, opposite the outside corner 107 (the two inside edges 106 and 126 meet at and define the corner 108).

The second leg 102 also has an upper surface 130 and an opposed lower surface 131 that each extend entirely between the base end 123 and the free end 124 and between the opposed edges 125 and 126. The upper and lower surfaces 130 and 131 are flat, smooth, and parallel to each other, spaced apart by a small thickness 132 of the second leg 102. This thickness 132 is equal to the thickness 112 of the first leg 101. The upper surface 130 of the second leg 102 is contiguous to and flush with the upper surface 110 of the first leg 101 and, likewise, the lower surface 131 of the second leg 102 is contiguous to and flush with the lower surface 111 of the first leg 101.

The second leg 102 further includes two slits: a proximal slit 133 and a distal slit 134. Both slits 133 and 134 are formed entirely through the second leg 102, from the upper surface 130 through to the lower surface 131. The slits 133 and 134 are slender and straight. The proximal and distal slits 133 and 134 are formed along a medial line 139 in the second leg 102, extending centrally through the second leg 102. In other words, the proximal and distal slits 133 and 134 are each located roughly halfway between the outside and inside edges 125 and 126.

The medial line 119 extending through the first leg 101 is offset with respect to the medial line 139 extending through the second leg 102. As such, the proximal and distal slits 113 and 114 in the first leg 101 are each offset to each of the proximal and distal slits 133 and 134 in the second leg 102. The nuts 50 are mounted in the square 12 for reciprocal movement in either direction along the medial lines 119 and 139. The medial lines 119 and 139 are perpendicular to each other, so that the nuts 50 move along the square in reciprocal directions that are perpendicular to each other.

The proximal slit 133 has a proximal end 135 and an opposed distal end 136. The proximal end 135 is located just inboard of the center 100, and the distal end 136 is located at an approximate midpoint along the length of the second leg 102.

Likewise, the distal slit 134 has a proximal end 137 and an opposed distal end 138. The proximal end 137 is located just beyond distal end 136 at the approximate midpoint of the second leg 102, and the distal end 138 is located inboard of the free end 124 by a distance equivalent to about twice the distance between the outside and inside edges 125 and 126.

As shown in FIGS. 1 and 2, the nut 50 is carried in the proximal and distal slits 133 and 134. In those drawings, the threaded shank 67 in the nut 50 extends through the proximal slit 133, with the body 51 of the nut below the square 12 and the head 65 above the square 12. The nut 50 is also applicable to the proximal slit 133 in a similar fashion to the distal slit 134, which the reader will readily understand without further explanation. The nut 50 can be slid by the carpenter along the full lengths of both the proximal and distal slits 133 and 134.

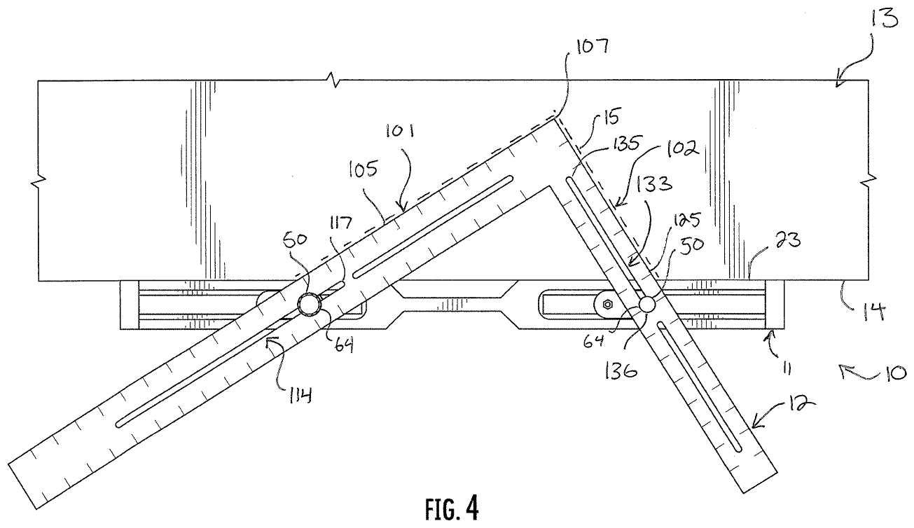

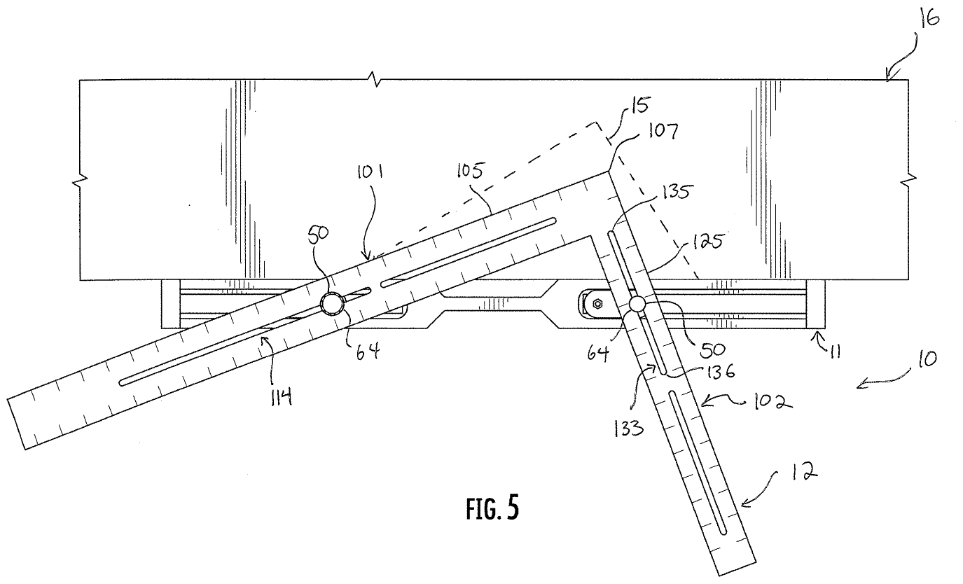

FIGS. 4 and 5 show operation of the jig 10 against lumber 13 and 16 workpieces. The lumber 13 has an outside edge 14 against which the carpenter has placed the inside edge 23 of the base 11 of the jig 10. FIG. 4 illustrates a first position or arrangement of the jig 10, and FIG. 5 illustrates a second position or arrangement of the jig 10. These are merely exemplary; there are many other arrangements of the jig 10.

In FIG. 4, the carpenter has adjusted the nuts 50 in the distal slit 114 of the first leg 101 and the proximal slit 133 of the second leg 102. He has brought the nut 50 in the distal slit 114 close to the proximal end 117 and the nut 50 in the proximal slit 133 entirely to the distal end 136. By doing this, the outside corner 107 of the square 12 is moved well away from the base 11. The outside corner 107, together with those portions of the outside edges 105 and 125 of the first and second legs 101 and 102, define two convergent lines forming a birdsmouth shape on the lumber 13. The carpenter can pick up a marking pencil and run it along the outside edges 105 and 125 on the lumber 13, thereby scrawling angular birdsmouth cut lines 15, as shown in broken lines in FIG. 4.

After marking the first set of cut lines 15, the carpenter repeats this process at an adjacent location along the outside edge 14 of the lumber 13. The carpenter will likely mark several sets of cut lines 15 along the lumber 13, so that he can later cut those lines and convert the lumber 13 into a stringer for a set of stairs, for example. If the carpenter does not loosen the nuts 50, this is easy, because all he needs to do is slide the jig 10 to the left or right and mark another set of cut lines 15, over and over.

Once the carpenter has finished marking all the cut lines 15 for a particular piece of lumber 13, he may move to another piece of lumber 16, shown in FIG. 5. For this lumber 16, the carpenter may need a differently sized and shaped birdsmouth. As such, he loosens the set screws 64 and adjusts the nuts 50 in the slits 114 and 133. The nuts 50 are spaced-apart points or locations at which the square 12 is slidably coupled to the base 11.

Movement of one or both of the nuts 50 imparts articulated movement of the square 12 with respect to the base 11. Holding either one of the nuts 50 stationary in place but adjusting the other will cause the square 12 to pivot about the stationary nut 50. Adjusting both nuts 50 causes the square 12 to pivot about two moving points, thereby resulting in articulated movement in which the square 12 can pivot, move laterally along the long axis 25, and/or move laterally along the short axis 26.

The square 12 is thus mounted to the base 11 for movement in either direction along the medial line 119, for movement in either direction along the medial line 139, and for movement in either direction along the long axis 25 of the base. Any of these types of movements imparts pivotal movement to the outside corner 107 and thus repositions the outside corner 107 with respect to the inside edge 23 of the base 11. When the carpenter has moved the nuts 50 to a position that orients the square 12 on the base 11 as desired, he re-tightens the set screws 64.

When the carpenter tightens the set screws 64, he binds the square 12 to the base 11. The underside of the set screw 64 has the contact face 66. The contact face 66 of the set screw 64 opposes the upper face 52 of the nut 50 to define a securement gap 68 between the set screw 64 and the body 51 of the nut 50. The square 12 is received in the securement gap 68.

The contact face 66 presses down in contact against the upper surface 110 of the square 12, and the square 12, in turn, presses against the base 11. The lower surface 111 of the square 12 presses down in contact against the upper face 30 of the base 11. The downward force of the square 12 against the base 11 creates a large friction force that resists movement of the square 12 with respect to the base 11.

In FIG. 5, the nut 50 in the slit 114 has been moved just slightly with respect to its position in FIG. 4, but the nut 50 in the slit 133 has moved from against the distal end 136 to approximately halfway between the proximal and distal ends 135 and 136. This causes the outside corner 107 to move closer to the base 11. FIG. 5 shows the cut lines 15 from FIG. 4 for comparison; the outside corner 107 and the outside edges 105 and 125 of the first and second legs 101 and 102 are now inside of the cut lines 15, so the birdsmouth cut formed from the arrangement shown in FIG. 5 will be much smaller and shallower than the one of FIG. 4.

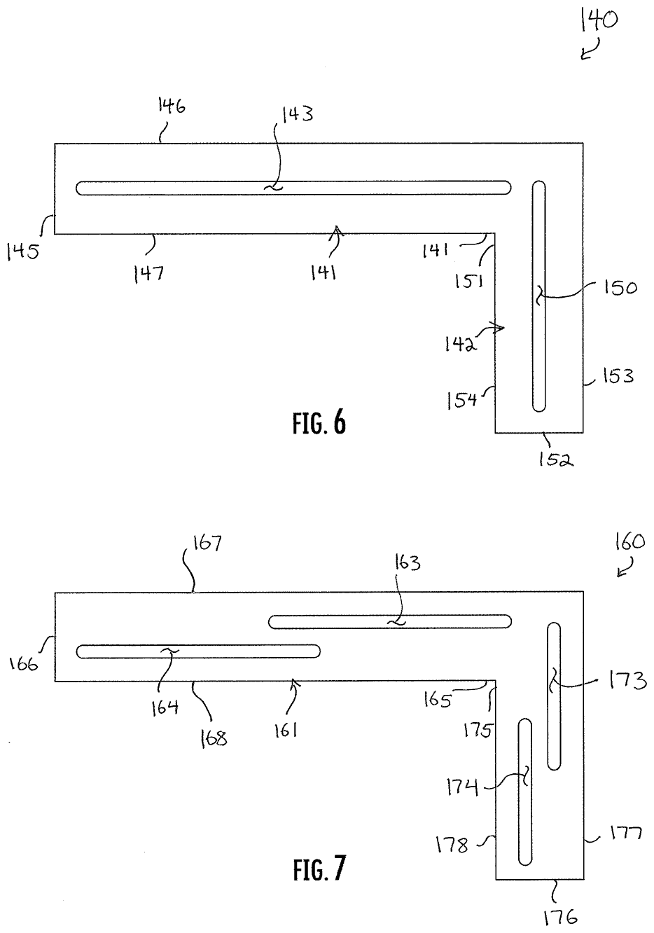

FIGS. 6 and 7 show alternate embodiments of the base 11. Both are similar to the base 11 but have differences.

FIG. 6 shows a base 140 with first and second legs 141 and 142 in top plan view. The first leg 141 has a single uninterrupted elongate slit 143 extending nearly entirely from a base end 144 to a free end 145. The slit 143 is formed along a medial line in the first leg 141, extending centrally through the first leg 141. In other words, the slit 143 is located roughly halfway between the outside and inside edges 146 and 147 of the first leg 141.

The second leg 142 also has a single uninterrupted elongate slit 150 extending nearly entirely from a base end 151 to a free end 152. The slit 150 is formed along a medial line in the second leg 142, extending centrally through the second leg 142. In other words, the slit 150 is located roughly halfway between the outside and inside edges 153 and 154 of the second leg 142.

FIG. 7 shows a base 160 with first and second legs 161 and 162 in top plan view. The first leg 161 has two elongate slits 163 and 164 extending along the length of the first leg 161. The proximal slit 163 extends from proximate a base end 165 to a location generally intermediate between the base end 165 and a free end 166 of the first leg 161. The distal slit 164 extends from another location generally intermediate between the base end 165 and the free end 166 to proximate the free end 166. The proximal and distal slits 163 and 164 are offset along a medial line extending centrally through the first leg 161. The proximal slit 163 is slightly closer to an outside edge 167, while the distal slit 164 is slightly closer to an inside edge 168. In other embodiments, this arrangement is reversed.

The second leg 162 has two elongate slits 173 and 174 extending along the length of the second leg 162. The proximal slit 173 extends from proximate a base end 175 to a location generally intermediate between the base end 175 and a free end 176 of the first leg 162. The distal slit 174 extends from another location generally intermediate between the base end 175 and the free end 176 to proximate the free end 176. The proximal and distal slits 173 and 174 are offset along a medial line extending centrally through the second leg 162. The proximal slit 173 is slightly closer to an outside edge 177, while the distal slit 174 is slightly closer to an inside edge 178. In other embodiments, this arrangement is reversed.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A jig comprising:
a base having an inside edge;
a square having a first leg with a first outside edge and a second leg with a second outside edge meeting at and defining a corner; and
the square is mounted to the base for sliding movement along the base.

2. The jig of claim 1, wherein the square is mounted to the base for articulated movement at two spaced-apart points.

3. The jig of claim 1, wherein the square is mounted to the base at two spaced-apart points, each of which is configured to reciprocate along two offset lines of reciprocal movement.

4. The jig of claim 1, further comprising:
first and second slides;
the first and second slides are mounted to the base for reciprocal movement in a first direction; and
the first and second slides are mounted to the square for reciprocal movement in a second direction.

5. The jig of claim 4, wherein the slides each comprise:
a nut having a body, the body having an upper face; and
a set screw threadably engaged in the body, the set screw having a lower face opposing the upper face and defining a securement gap therebetween.

6. The jig of claim 5, wherein the nut includes two threaded bores spaced apart from each other on the upper face, each being configured to receive the set screw.

7. A jig comprising:
a base having an inside edge extending along a first track portion and an opposed second track portion of the base;
a square having a first leg with a first outside edge and a second leg with a second outside edge meeting at and defining a corner;
the first leg of the square is mounted to the first track portion of the base for sliding movement; and
the second leg of the square is mounted to the second track portion of the base for sliding movement.

8. The jig of claim 7, wherein the first and second track portions are separated by a grip between the first and second portions.

9. The jig of claim 7, wherein the first and second track portions each include an elongate slot carrying a slide which slidably couples the square to the base.

10. The jig of claim 9, wherein each slide is carried in the respective elongate slot for reciprocal movement.

11. The jig of claim 10, wherein:
the slide mounted in the elongate slot in the first track portion is carried for reciprocal movement in the first track portion along a first direction;
the slide mounted in the elongate slot in the second track portion is carried for reciprocal movement in the second track portion along a second direction; and
the first direction is perpendicular to the second direction.

12. The jig of claim 11, wherein the slides each comprise:
a nut having a body, the body having an upper face; and
a set screw threadably engaged in the body, the set screw having a lower face opposing the upper face and defining a securement gap therebetween.

13. The jig of claim 12, wherein the nut includes two threaded bores spaced apart from each other on the upper face, each being configured to receive the set screw.

14. A jig comprising:
a base having an inside edge extending along both a first portion and an opposed second portion;
a square having a first leg with a first outside edge and a second leg with a second outside edge meeting at and defining a corner; and
the square is mounted to the base for movement along a first direction extending along the first leg and along a second direction extending along the second leg;
wherein movement along the base in either of the first and second directions imparts pivotal movement of the corner with respect to the inside edge.

15. The jig of claim 14, wherein the square is mounted to the base for movement along a third line extending along the base.

16. The jig of claim 15, wherein:
the first leg of the square is mounted to the first portion of the base for sliding movement along the first direction; and
the second leg of the square is mounted to the second portion of the base for sliding movement along the second direction.

17. The jig of claim 16, wherein:
the base includes first and second track portions, each having an elongate slot carrying a slider to which the square is coupled; and
the first and second track portions are separated by a grip.

18. The jig of claim 17, wherein:
the slide carried in the elongate slot in the first track portion is carried for reciprocal movement in the first track portion along a first direction;
the slide carried in the elongate slot in the second track portion is carried for reciprocal movement in the second track portion along a second direction; and
the first direction is perpendicular to the second direction.

19. The jig of claim 18, wherein the slides each comprise:
a nut having a body, the body having an upper face; and
a set screw threadably engaged in the body, the set screw having a lower face opposing the upper face and defining a securement gap therebetween.

20. The jig of claim 19, wherein the nut includes two threaded bores spaced apart from each other on the upper face, each being configured to receive the set screw.
